(19) United States
(12) Patent Application Publication
(10) Pub. No.: US 2010/0019906 A1
(43) Pub. Date: Jan. 28, 2010

(54) ARTICLE MANAGEMENT SYSTEM AND METHOD FOR MANAGING ARTICLE

(75) Inventors: Hiroyuki KUSHIDA, Kanagawa (JP); Shinji Saegusa, Shizuoka (JP)

Correspondence Address: PATTERSON & SHERIDAN, L.L.P., 3040 POST OAK BOULEVARD, SUITE 1500, HOUSTON, TX, 77056, US

(73) Assignee: Toshiba TEC Kabushiki Kaisha, Tokyo (JP)

(21) Appl. No.: 12/485,854

(22) Filed: Jun. 16, 2009

(30) Foreign Application Priority Data
Jul. 27, 2008 (JP) JP 2008-169098

(51) Int. Cl. H04B 7/00

(52) U.S. Cl. 340/572.1

(57) ABSTRACT

An article management system includes an article location specifying means which outputs a location information of an article by relating an object location information with an article identification information. Radio tag information including the article identification information is output from a radio tag reading means which executes through a leaky transmission path a communication with a radio tag affixed on the article on a table section and the object location information is output from an object detection means when detecting the object approaching the table section.

### CROSS-REFERENCE TO RELATED APPLICATION

This application is related to copending and commonly owned U.S. patent application Ser. No. 12/370,439 filed Feb. 12, 2009 in the name of Hiroyuki Kushida, et al., the entire disclosure thereof being expressly incorporated herein by reference.

### BACKGROUND OF THE INVENTION

1. Field of the Invention

This invention relates, in general, to an article management system for managing articles. In particular, the invention relates to an article management system that automatically manages an article, for example, inventory of commodities, parts or the like taken into or out of a shop or a warehouse.

2. Description of the Related Art

In the past, management of commodities or parts at a shop or a warehouse is carried out by a shop clerk or an operator with their eyes. Such a management is, however, very troublesome and not efficient. And also, such human operation may take mistakes and thus it is desired to introduce a system that decreases mistakes occurred with the human operation.

In recent years, a radio tag such as RFID tag has been developed and is taken in a practical use. The RFID tag (Radio Frequency Identification tag) is composed of an antenna and an IC chip that includes a memory section, a communication section and a control section for controlling memory and communication sections. In the RFID tag, an ID code (Identification Code) for uniquely specifying an article and information attributed to the article are stored in the memory thereof beforehand and then the RFID tag is attached to the article to perform an inventory management of the article with the RFID tag at a shop or a warehouse.

Japanese Patent Publication (KoKai) No. 2001-31218 discloses an article management system that includes an RFID tag storing an ID code for specifying an article and attached to the article, and a reading unit for performing a transmission/reception of data with the RFID tag. In this system, a plurality of reading units each is provided to compartments respectively at which articles are displayed, and addresses are assigned to compartments, respectively. By performing a communication between one of the reading units and an RFID tag attached to an article, an article management can be carried out with an ID code sent from the one of the reading units which executes communication with the RFID tag and, an address which is assigned to a specific compartment the article is displayed.

However, in this article management system, since an area covered by each reading unit that is installed at each compartment becomes wide if the area in which articles are displayed is set to be large, it may be practically difficult to specify a location that a target article is displayed. On the other hand, if the compartment is set to be small, a distance between reading units each of which is installed at respective compartments becomes narrow, and thus it is also difficult to specify the display location of the article. This is because that a mutual interference between units may occur and/or reading an RFID tag of neighboring compartment may also occur in error. Such problems are caused because of location of an article being specified only by address assigned to each compartment that a reading unit is installed. Further more, in this system, it is not considered that an error in acquisition of movement information of an article may occur due to the occurrence of failure of data reading of the reading unit and thus a secure inventory management is difficult.

### SUMMARY OF THE INVENTION

Accordingly, it is an object of the present invention to certainly manage location of an article displayed or stored in a shop or a warehouse.

To accomplish the above-described object, an article management system comprises a leaky transmission path arranged at a table section on which an article is placed, a radio tag reading means, which carries out communication with a radio tag affixed on the article on the table section through the leaky transmission path, for outputting a radio tag information including an article identification information, an object detection means for detecting an object approaching the table section for outputting an object location information, and an article location specifying means, which relates the object location information with the article identification information, for outputting it as a location information of the article.

### BRIEF DESCRIPTION OF THE DRAWINGS

This and other objects and advantages of this invention will become apparent and more readily appreciated from the following detailed description of the presently preferred exemplary embodiments of the invention taken in conjunction with the accompanying drawings wherein:

FIG. 1 is a schematic perspective view illustrating an article management system according to the present invention;

FIG. 2 is a block diagram illustrating a hardware configuration of a sensor section shown in FIG. 1;

FIG. 3 is a block diagram illustrating a hardware configuration of an RFID tag reader section shown in FIG. 1;

FIG. 4 is a block diagram illustrating a hardware configuration of a system management section shown in FIG. 1;

FIG. 5 is a schematic view illustrating the sensor section shown in FIG. 2;

FIG. 6 is a perspective view schematically illustrating a structure of the sensor section and display shelves shown in FIG. 1;

FIG. 7 is a front view illustrating the sensor section and the display shelves shown in FIG. 6;

FIG. 8 is a view showing a data structure of an object location data table of a system management section;

FIG. 9 is a view showing a data structure of a valid area table of the system management section;

FIG. 10 is a view indicating a data structure of an RFID tag memory table of an RFID tag;

FIG. 11 is a view indicating a data structure of an RFID tag data buffer of the RFID tag;

FIG. 12 is a view showing a data structure of an RFID tag data table of the system management section;

FIG. 13 is a view showing a data structure of an article location-specifying table of the system management section;

FIG. 14 is a view illustrating a display screen of an output section of the system management section;

FIG. 15 is a flow chart showing a main process of the article management system;

FIG. 16 is a flow chart showing an object detecting process;

FIG. 17 is a flow chart showing an RFID tag data reading process;

FIG. 18 is a flow chart showing an article location specifying process;

FIG. 19 is a flow chart showing a main process of an article management system according to a second embodiment of the present invention; and

FIG. 20 is a flow chart showing a main process of an object detection process according to the second embodiment of the present invention.

### DETAILED DESCRIPTION OF THE INVENTION

Preferred embodiments of the present invention will now be described in more detail with reference to the accompanying drawings. However, the same numerals are applied to the similar elements in the drawings, and therefore, the detailed descriptions thereof are not repeated

### First Embodiment

A first embodiment of the present invention will be described by referring to the drawings.

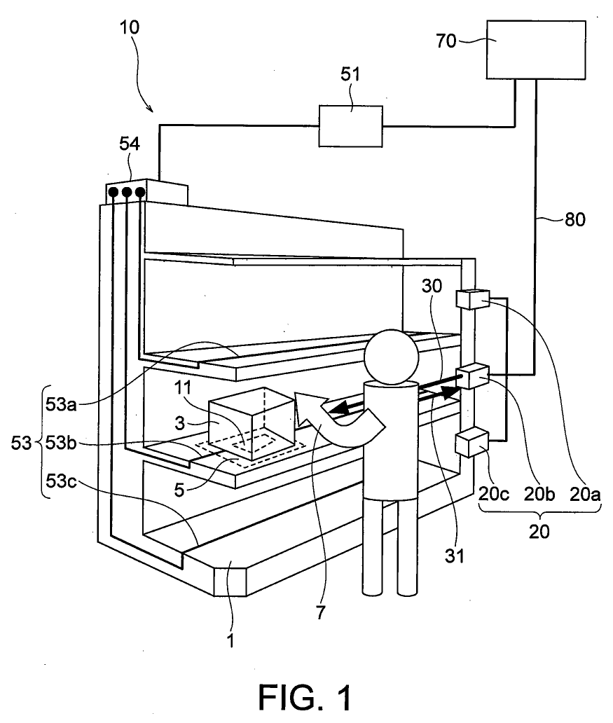

FIG. 1 shows a first embodiment of an article management system of the present invention.

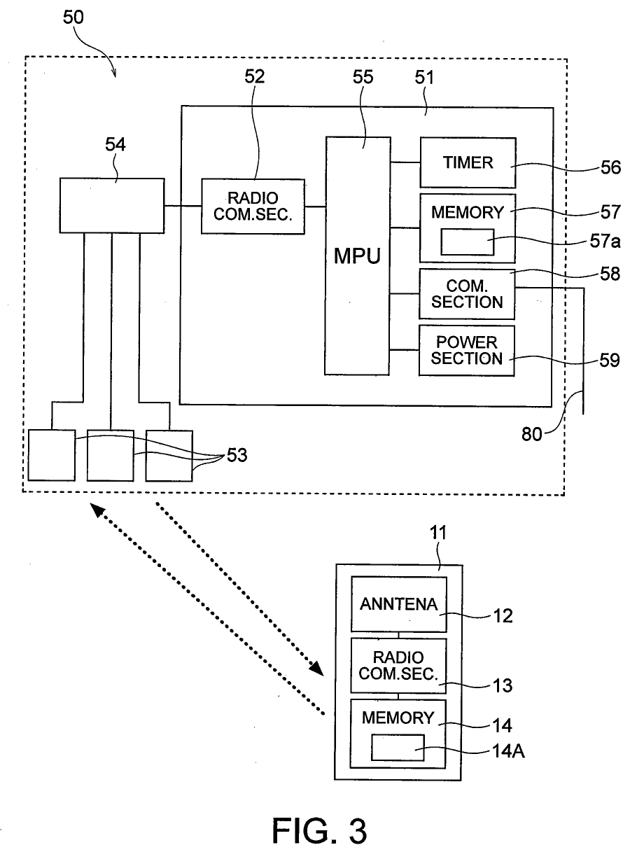

The article management system 10 is composed of a sensor section 20 acting as an access detecting means, an RFID tag reader section 50 (FIG. 3) acting as a radio tag reading means, and a system management section 70 acting as an information processing apparatus.

The sensor section 20 includes, for example, a first sensor sub-section 20a, a second sensor sub-section 20b and a third sensor sub-section 20c and as shown in FIG. 1, each sensor sub-section is installed at a corresponding shelf element of display shelf 1 in a shop, for example. Since the sensor sub-section 20a, 20b, 20c respectively has a same hardware construction and functions thereof, in the first embodiment, the construction and functions of the second sensor sub-section 20b will be described later.

When an object 7 approaching an article 3 displayed on the display shelf (table section) 1 or an article display area (article placement area) 5 is detected, a sensor, e.g., second sensor sub-section 20b, measures a distance to the object 7 and sends the measured distance to the system management section 70 as an object location data.

The object 7 detected by the second sensor sub-section 20b may be a hand or an arm of a shop clerk or an operator who carries out reception/transfer of an article or an arm of a robot that also carries out reception/transfer of an article. The object 7 may also be an article moved by reception/transfer operation. It is determined by this detection operation that an access to the article occurs. A method for measuring a distance to the object 7 by the second sensor sub-section 20b will be described later.

The RFID tag reader section 50 is an interrogator well known in the art and is composed of an RFID reader 51, a leaky transmission path 53a, 53b, 53c acting as an antenna and a switchover device 54, as shown in FIG. 3. The RFID reader 51 modulates a continuous wave with an interrogation signal and the modulated continuous wave is radiated through one of the leaky transmission paths 53a, 53b and 53c, which is sequentially selected by the switchover device 54. When an RFID tag 11 attached to the article 3 receives the modulated continuous wave, the RFID tag executes a prescribed communication protocol to send a response wave modulated with an RFID tag data to the RFID reader 51. The RFID tag data includes a tag code for uniquely identifying an RFID tag, an article code (article identifying code), and an article name.

The RFID reader 51 receives the modulated response wave through the leaky transmission path 53a, 53b or 53c. To be concrete, the reader 51 receives through one of the leaky transmission paths 53a, 53b and 53c the modulated response wave from the RFID tag 11 which locates at a communicable area of the one of the leaky transmission paths, demodulates the received response wave by a known method and stores the tag data demodulated in a memory.

The leaky transmission paths 53a, 53b and 53c may be a leaky coaxial cable or a leaky wave-guide. A radio-wave radiation characteristic of the leaky transmission paths 53a, 53b and 53c is different from that of a general single-type antenna, such as, whip antenna, dipole antenna etc. Namely, radiation pattern is formed in a fan shape as seen from an extending direction of the leaky transmission path and is extended along the entire length of the leaky transmission path. The field intensity is greater near the leaky transmission path and becomes gradually smaller as it comes away from the leaky transmission path. A detail construction and function of the leaky transmission path is disclosed in U.S. Pat. No. 7,302,228, the content and disclosure of which is herewith incorporated by reference.

The leaky transmission paths 53a, 53b and 53c may be arranged along each shelf (shelf element) of the article display shelf 1, correspondingly. Or, it may be arranged within the ceiling panel or backside panel of the article display shelf 1 or the article display shelf 1 so that it does not hinder the operation when article is put on the shelf. In short, the leaky transmission path may be arranged in a state that it can communicate with an article to be read out and thus, it may not be limited to arrange in a specific configuration.

The system management section 70 is connected to the sensor section 20 and the RFID tag reader section 50 through a communication line 80, e.g., a LAN (Local Area Network), an exclusive line or the like, and is input the object location data from each sensor sub-section 20a, 20b, 20c, and the RFID tag data from the RFID reader section 50 to execute a later described process based on the data inputted.

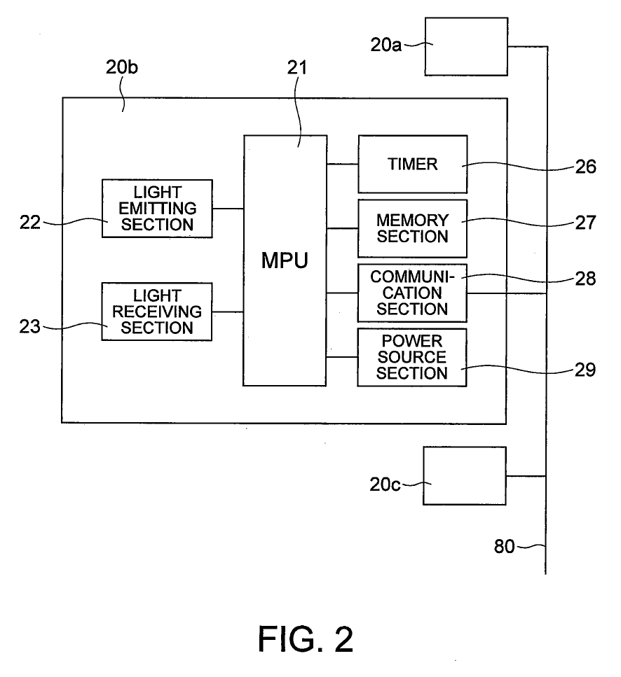

A construction of the sensor section 20 of the article management system 10 will be described with reference to FIG. 2.

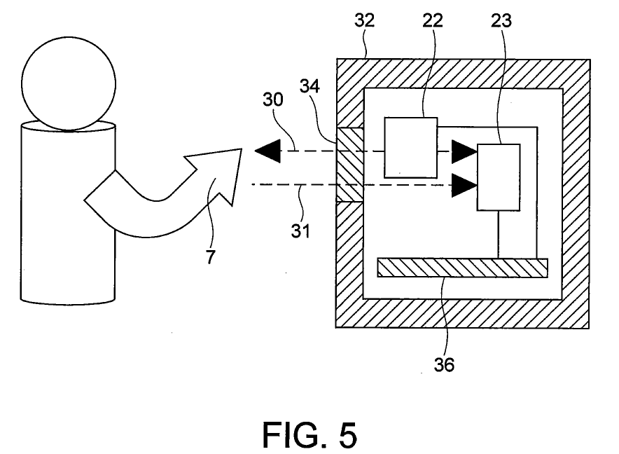

The second sensor sub-section 20b includes a control section 21 composed of an MPU (Micro Processing Unit), a light emitting section 22, shown in FIG. 5, radiating a projection light 30 and a light receiving section 23 detecting a reflection light 31 from the object 7. Furthermore, the second sensor sub-section 20b also includes a timer section 26, a memory section 27 composed of a hard disc drive (HDD) or a semiconductor memory, a communication section 28 and a power source section 29. The communication section 28 performs a transmission/reception of various data with the system management section 70.

As shown in FIG. 3, the RFID tag reader section 50 is composed of an RFID reader 51, the leaky transmission paths 53a, 53b and 53c and the switchover device 54. The RFID reader 51 includes a control section 55 having an MPU, a timer section 56, a memory section 57, a communication section 58 that performs a transmission/reception of data with the system management section 70 and a power source section 59. Furthermore, the RFID reader 51 includes a radio communication section 52 which carries out a communication with the RFID tag 11 through the leaky transmission path 53a, 53b or 53c. The memory section 57 includes a data buffer 57a that stores the above-described RFID tag data (tag code, article code and article name).

The RFID tag 11 which carries out a communication with the RFID reader 51 is composed of an antenna 12, a radio-communication section 13 and a memory section 14. The memory section 14 includes an RFID tag memory table 14A.

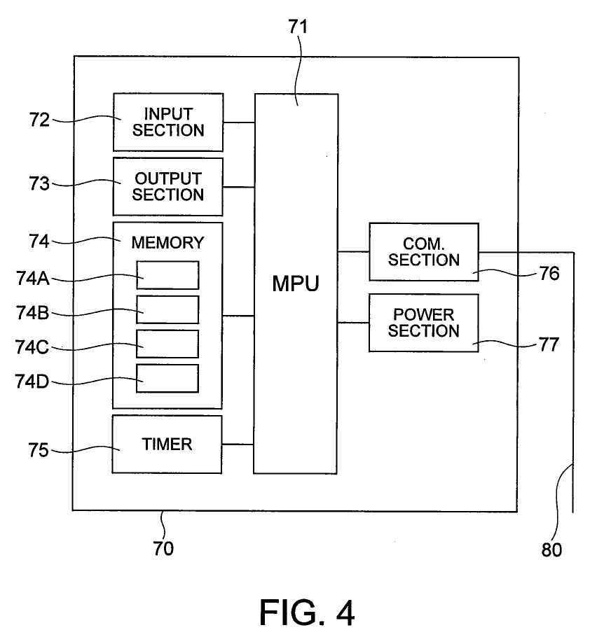

FIG. 4 is a block diagram illustrating a hardware construction of the system management section 70 shown in FIG. 1.

The system management section 70 includes a control section 71 having an MPU for controlling each hardware device, an input section 72 composed of a key board or a pointing device, i.e., mouse, and an output section 73. The output section 73 is a display device such as a liquid crystal display or an EL (Electro-Luminescent) display, or a printer. The system management section 70 further includes a memory section 74 such as a hard disc drive (HDD) or a semiconductor memory, a timer section 75, a communication section 76 and a power source section 77. The communication section 76 carries out a data transmission/reception with the sensor section 20, the RFID tag reader section 50 and other system. The memory section 74 includes an object location data table 74A, a valid area table 74B, an RFID tag data table 74C and an article location specifying table 74D.

A construction of the sensor section 20 acting as an access detection means of the article management system 10 will be described with reference to FIG. 5. In this embodiment, as described above, construction of the second sensor sub-section 20b will be described.

The sensor sub-section 20b includes a housing 32 in which a light emitting section 22, a light receiving section 23 and a sensor control section 36 are assembled. The housing 32 is formed in a cylindrical shape, for example, and a transparent window 34 is formed around the housing 32 at an angle of 180 degrees. The light emitting section 22 and the light receiving section 23 are exposed to the transparent window 34. The light emitting section 22 is a light source, e.g., an infrared ray laser diode, an LED (Light Emitting Diode), and the light receiving section 23 is a light sensor, e.g., a photo diode.

The sensor control section 36 acts as an object location detecting means and is composed of a control section 21, a timer 26, a memory section 27, a communication section 28 and a power source section 29 each being shown in FIG. 2 to control a light emission by the light emitting section 22 and to calculate a distance from the sensor sub-section 20b to the object 7.

A distance from the sensor section 20 to the object 7 is calculated, as follows, by a projected light from the light emitting section 22 and a reflected light by the object 7.

A first method for calculating the distance is disclosed as following:

As described above, an infrared ray laser light is projected, as a projected light 30, from the light emitting section 22. This projected light 30 is reflected by the object 7 to be a reflected light 31, and then the reflected light 31 is detected by the light receiving section 23. The distance is obtained from each speed of both the projected light 30 and reflected light 31 (basis for calculating a distance), and a time difference, i.e., time of round traveling of the projected light 31, between a time that the light 30 is projected and a time that the reflected light 31 is detected.

A second method is as following:

An infrared ray laser light projected from the emitting section 22 is modulated with a sine wave having a constant frequency and the distance is obtained from the phase difference between the projected light 30 and the reflected light 31. However, this method that the distance is obtained from the phase difference cannot measure a distance that is beyond a phase difference more than one cycle. Therefore, it is required to determine the modulating frequency based on the maximum detection distance that is predetermined.

Another method for detecting the distance is that:

Instead of the infrared ray laser light, a sound wave having a frequency more than 20 kHz is used such that the sound wave is radiated and the reflected wave thereof is detected. Thus, it is possible to measure a distance to the object 7 based on a time difference between the time that the sound wave is radiated and the time that the reflected sound wave is detected.

As described above, the sensor control section 36 calculates a distance from the sensor sub-section 20b to the object 7, as a distance data, based on the time difference between the time that the projected light 30 is generated by the light emitting section 22 and the time that the reflected light 31 is detected by the light receiving section 23. Next, the sensor control section 36 transmits an object location data to the system management section 70. The object location data is composed of the distance data, a sensor identifying data for identifying a sensor sub-section 20b and the time that the reflected light 31 is detected.

The system management section 70 carries out processes based on the object location data received from the sensor sub-section 20b.

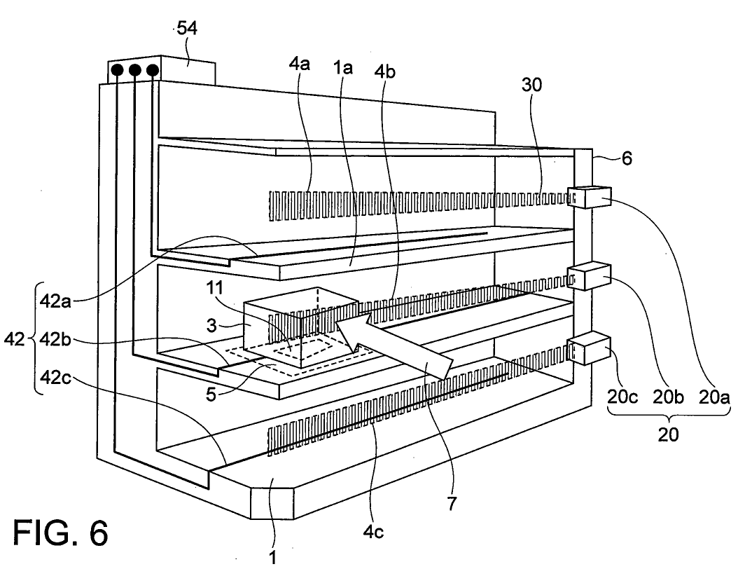

FIG. 6 is a perspective view illustrating a state that the sensor section 20, composed of the first sensor sub-section 20a, the second sensor sub-section 20b and the third sensor sub-section 20c, is set at the article display shelf 1, as similar to FIG. 1. Each sensor sub-section 20a, 20b, 20c detects either an article 3 displayed on the article display shelf 1 or the object 7 approaching a display area 5 of the article 3.

Each sensor sub-section 20a, 20b, 20c is respectively provided, corresponding to each shelf element, at its one end portion. For example, the sensor sub-section 20a is provided at the front surface of its sidewall 6 such that the light emitting section 22 and the light receiving section 23 face the front surface of the shelf that forms an opened article taking in and out area of the article display shelf 1. As shown in FIG. 6, the projected light 30, having a width, that is projected from the light emitting section 22 of the sensor sub-section 20a forms an access detecting area 4a at an opening of the article display shelf 1a. Other sensor sub-sections 20b and 20c are also provided at the article display shelf 1 as the same as the sensor sub-section 20a.

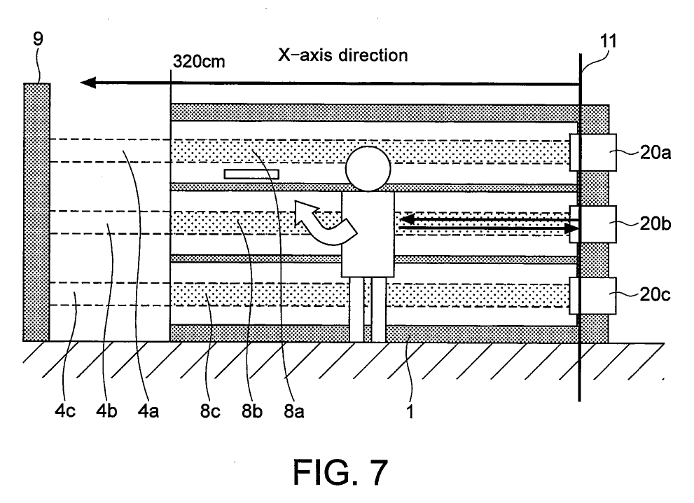

FIG. 7 is a front view illustrating the article display shelf 1. In this embodiment, the width of the article display shelf 1 is 320 cm, for example, in an X-axis direction indicated in the FIGURE from an ideal line 11 (datum line) connecting locations of each sensor sub-section 20a, 20b, 20c.

As shown in FIG. 6, access detection areas 4a, 4b and 4c, each having a width, are respectively formed by the projected light 30 from sensor sub-sections 20a, 20b and 20c. Thus, not only an article 3 on the article display shelf 1 or an object 7 approaching the article display area 5 but also a structure 9 within a shop, e.g., pillar, wall, etc, that the article display shelf 1 locates as a fixed background item that are not an object to be detected may be detected. Furthermore, a shop clark standing adjacent to the article display shelf 1, a customer or a moving background item, e.g. cart, etc., may also be detected. To specify location of an article 3 displayed on the article display shelf 1, it is required to exclude a location data of such fixed or moving background item from an object detected.

To exclude a location data of background item, the system management section 70 specifies a detection area corresponding to the article display shelf 1, as an upper limit of a valid detection area among access detection areas 4a, 4b and 4c and carries out a process in which a location data of the background item detected outside this valid detection area is eliminated.

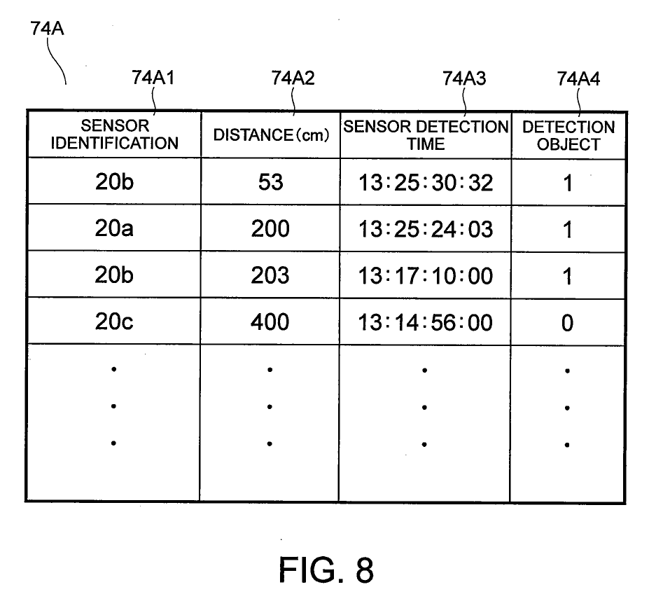

FIG. 8 shows a structure of an object location data table 74A of memory section 74 of the system management section 70. The object location data table 74A is composed of a sensor identification data column 74A1, a distance data column 74A2, a sensor detection time data column 74A3 and a detection object data column 74A4. An object location data including a sensor identification data for discriminating each sensor sub-section 20a, 20b or 20c that has output a detection signal in the sensor section 20, a distance data, and a detection time data are stored in corresponding data columns.

When a judgment is made that a location data inputted represents a detected object, “1” is stored in the detection object data column 74A4 and “0” is stored otherwise. Based on the distance data, it is possible to make a judgment as to whether or not an inputted location data represents a detected object.

FIG. 9 indicates a construction of a valid area table 74B of memory section 74 of the system management section 70. The valid area table 74B functions as a valid area storing means to store an upper limit value of valid detection area in a detectionable area respectively formed by sensor sub-sections 20a, 20b and 20c.

The valid area table 74B includes a sensor identification data column 74B1, a shelf data column 74B2 and an upper limit value data column 74B3. The sensor identification data column 74B1 stores an identification data of each sensor sub-section. The shelf data column 74B2 stores a shelf data for identifying a shelf element that each sensor sub-section 20a, 20b, 20c is provided. The upper limit value data column 74B3 stores an upper limit value (area information) of the valid detection area of each sensor sub-section 20a, 20b, 20c.

In this embodiment, a width of the article display shelf 1 (320 cm) is stored beforehand, as an upper limit value, in the upper limit value data column 74B3. A location data exceeding the upper limit value is excluded from the detected object as a location data of background item (a non-detected object).

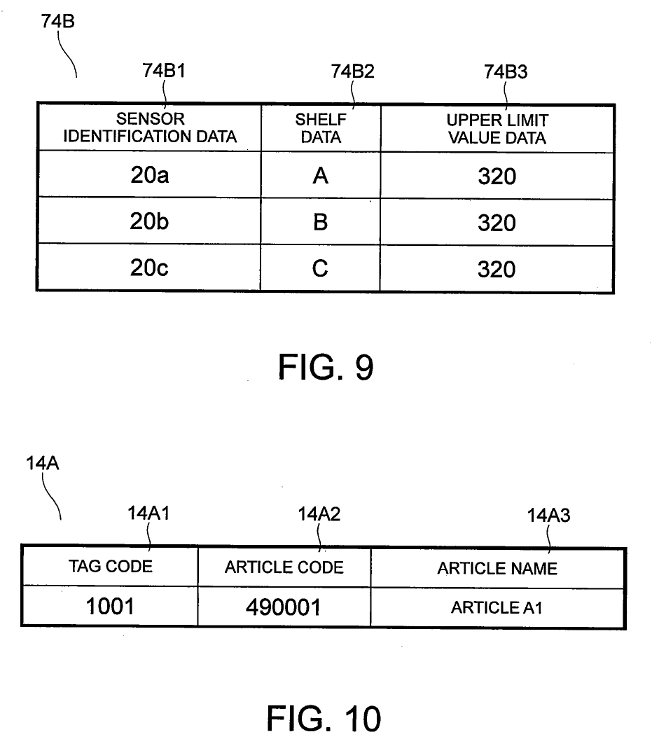

FIG. 10 is a view illustrating an RFID tag memory table 14A of a memory section 14 of RFID tag 11. The table 14A includes a tag code column 14A1, an article code column 14A2 and an article name column 14A3. The tag code column 14A1 stores a tag code for identifying RFID tag, the article code column 14A2 stores an article code for identifying an article and the article name column 14A3 stores an article name corresponding to the article code.

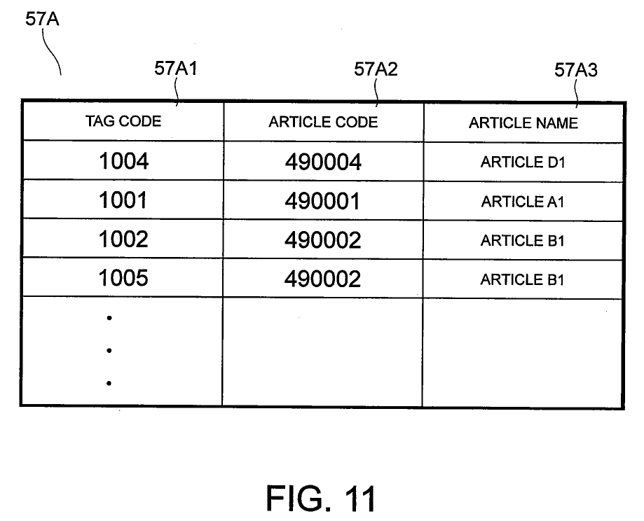

FIG. 11 is a view illustrating an RFID tag data buffer 57a of the memory section 57 of the RFID tag reader 51. The data buffer 57a includes a tag code column 57A1, an article code column 57A2 and an article name column 57A3.

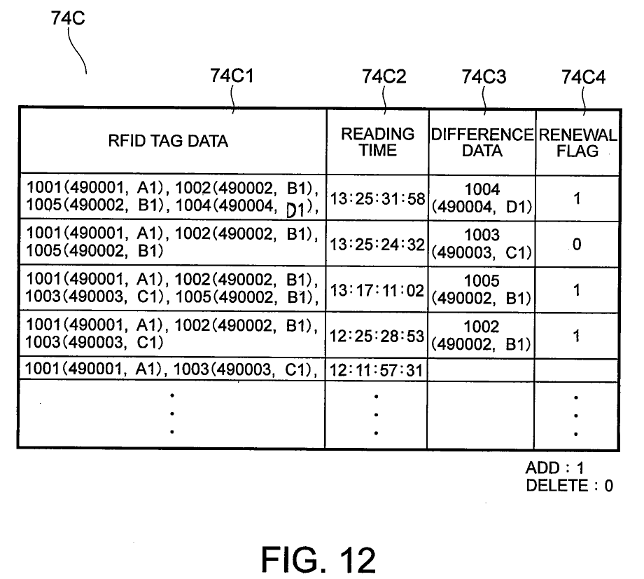

FIG. 12 shows structure of an RFID tag data table 74C of the memory section 74 of the system management section 70. The data table 74C includes an RFID tag data column 74C1, a reading time column 74C2, a difference data column 74C3 and a renewal flag column 74C4.

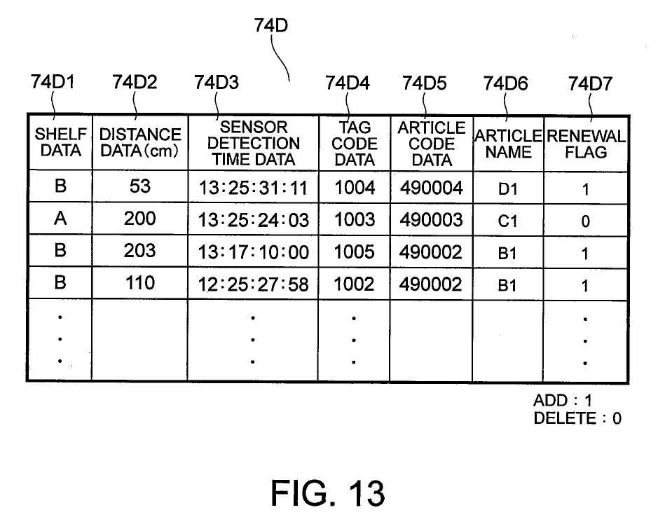

FIG. 13 is a view illustrating an article location specifying table 74D of the memory section 74 of the system management section 70. The table 74D includes a shelf data column 74D1 for storing an object location data, a distance data column 74D2, a sensor detection time data column 74D3, a tag code data column 74D4, an article code data column 74D5, an article name column 74D6 and a renewal flag column 74D7.

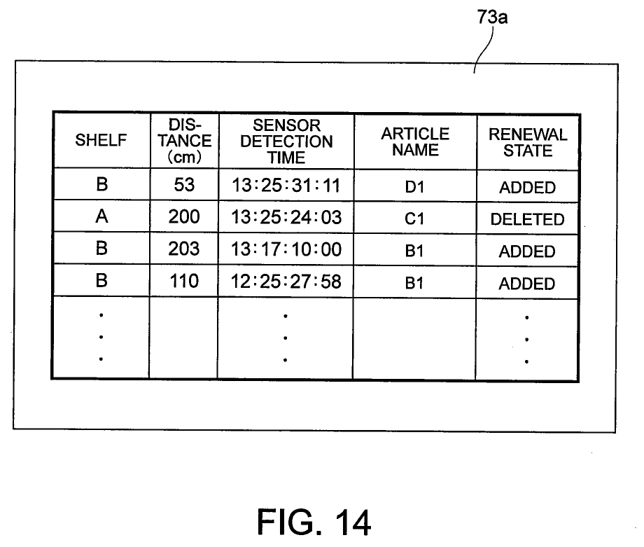

FIG. 14 is a view illustrating a display screen 73a, e.g., liquid display, organic EL (electro-luminescent) display, etc., that constitutes an output section 73 of the system management section 70.

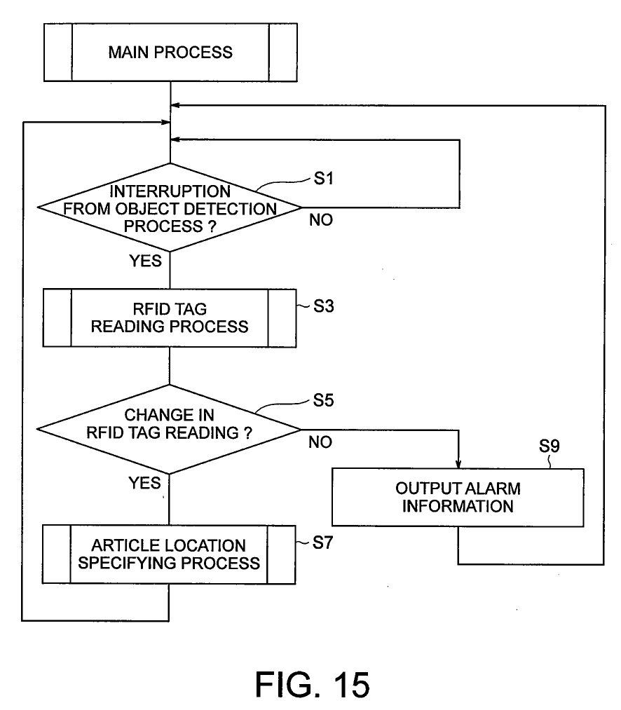

An explanation will be held as to a process of article management system 10, referring to FIGS. 15 to 18.

FIG. 15 is a flow chart illustrating a main process that is executed by an MPU 71 of the system management section 70. The MPU 71 detects interruption of an object detection process that is executed when the sensor section 20 detects the object 7 (step S1).

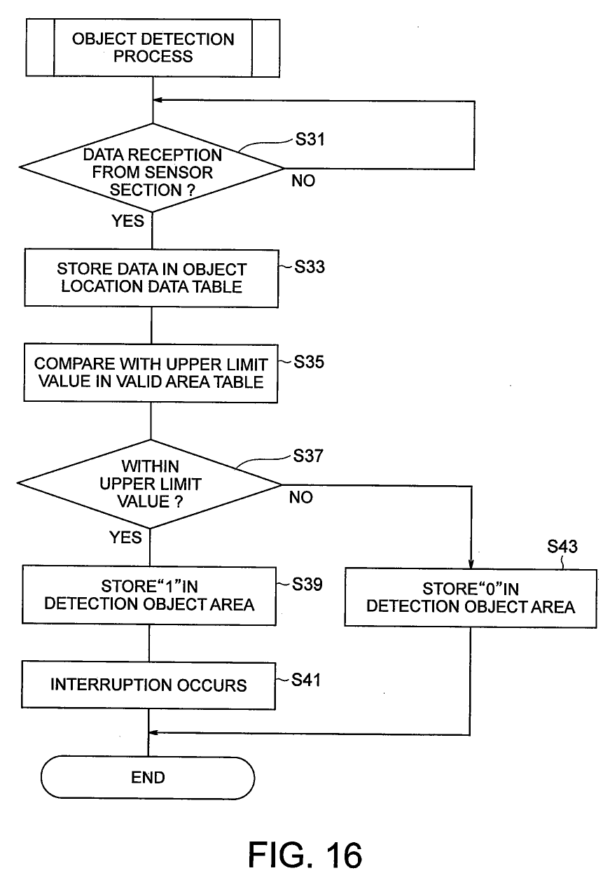

Here, the object detection process will be described with reference to FIG. 16. FIG. 16 is a flow chart of the object detection process carried out by the MPU 71. The object detection process acts as an object location information acquiring means. Each sensor sub-section 20a, 20b, 20c constituting the sensor section 20 calculates a distance to the object 7 respectively and sends the object location data including each calculated distance data and a detection time data, etc., together with sensor identification data for identifying one of the sensor sub-sections. In step S31, YES-path is taken when the system management section 70 receives the object location data from one of the sensor sub-sections 20a, 20b and 20c, and thus executes step S33. Otherwise, NO-path is taken. In step S33, the object location data received is stored in the object location data table 74A shown in FIG. 8. The sensor identification data of the object location data is stored in the sensor identification data column 74A1, the distance data is stored in the distance data column 74A2 and the detection time data is stored in the sensor detection time data column 74A3.

Next, in step S35, the distance data stored in the distance data column 74A2 of the object location data table 74A is compared with an upper limit value data of valid detection area of each sensor sub-section that has been previously stored in the upper limit value data column 74B3 of the valid area table 74B shown in FIG. 9. According to this comparison, NO-path is taken if the distance data does not fall within the upper limit value in step S37 and step S43 is executed. In step S43, “0” is stored in the detection object data column 74A4 of the object location data table 74A and then the object detection process is finished. This is because that the object 7 is detected at the outside of the valid detection area of the article display shelf 1.

In step S37, YES-path is taken if the distance data falls within the upper limit value data. In this case, since the object 7 is detected within the valid detection area of the article display shelf 1, “1” is stored in the detection object data column 74A4 of the object location data table 74A in step S39. An interruption signal is issued to the main process in the next step S41 and then the object detection process is completed.

In this object detection process, an object location data (sensor identification data, distance data and detection time data) is stored in the object location data table 74A. Furthermore, a judgment is made whether or not the location that the article 3 is detected falls within the valid detection area of the sensor section 20 and the result is stored in the detection object data column 74A4. Thus, this process enables only an article 3 displayed on the article display shelf 1 or an object 7 approaching the article display area 5 to be identified as a detected object.

After this object detection process is completed, as described above, it returns to the main process shown in FIG. 15. An interruption signal is detected in step S1 and thus an RFID tag reading process (step S3) is executed.

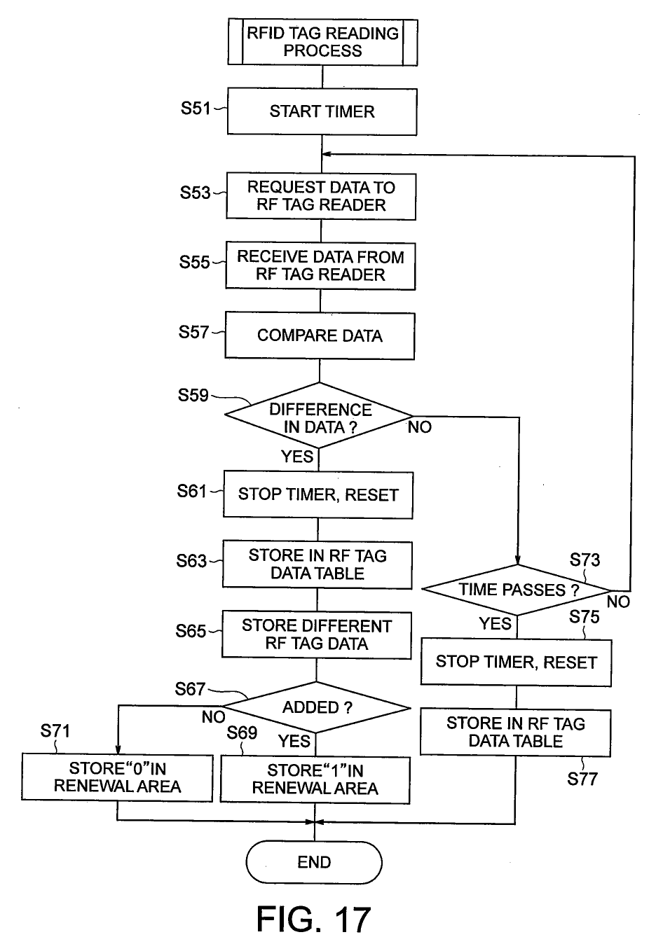

FIG. 17 is a flow chart illustrating an RFID tag reading process. The RFID tag reading process functions as an article identification information acquisition means and a radio tag reading information acquisition means. When the article management system 10 is activated, the RFID tag reader section 50 continuously sends through leaky transmission paths 53a, 53b or 53c sequentially switched over by the switchover device 54 a radio wave including an interrogation signal, as being well known in this field, to read data stored in the memory section 14 of the RFID tag 11. The RFID tag 11 that receives the radio wave for reading through the antenna 12 establishes a known communication method (e.g., backscatter communication) with the reader section 50 according to a prescribed communication protocol and reads out each data of a tag code, an article code and an article name stored in the memory section 14. Then, a responding radio wave including each data as described above is transmitted from the antenna 12 of the RFID tag 11 to the leaky transmission path 53 of the reader section 50. The reader section 50 that receives the responding radio wave through one of the leaky transmission paths 53 sequentially switched over by the switchover device 54 extracts (decode) an RFID tag data (radio tag information) including a tag code, an article code and an article name from the responding radio wave by a known process. Finally, the RFID tag data is stored in the RFID tag data buffer 57a of the memory section 57 of the RFID tag reader section 51.

At this moment, to prevent a double or twice reading, data in the RFID tag data buffer 57a is retrieved with a unique tag code that is extracted at present and if the same tag code has been stored in the buffer 57a, the RFID tag data that is extracted at present is annulled. Otherwise, the RFID tag data is stored in the buffer 57a.

Next, as shown in FIG. 17, the system management section 70 starts a timer 75 (step S51) and requests a transmission of the RFID tag data that is read out by the RFID reader section 50 (step S53). In response to this request, the RFID tag reader section 50 sends the RFID tag data stored in the RFID tag data buffer 57a to the system management section 70.

The system management section 70 receives the RFID tag data transmitted (step S55), and compares the received RFID tag data (this time RFID tag data) with the RFID tag data (last time RFID tag data) that is stored in the RFID tag data table 74C just prior to this comparison (step S57). In this case, it may compare with the RFID tag data (tag code, article code and article name) but may compare with only a tag code because of its uniqueness.

In step S59, if it is determined that this time RFID tag data and the last time RFID tag data are the same, No-path is taken and in step S73, it is judged whether or not the count value of the timer 75 exceeds a prescribed value. When the count value of the timer 75 does not exceed the prescribed value, NO-path is taken and steps S53˜S59 are executed, repeatedly. In step S73, if it is judged, on the other hand, that the count value of the timer 75 exceeds the prescribed value, YES-path is taken and step S75 is executed. Count operation of the timer 75 stops and the counted value thereof is cleared. Furthermore, in step S77, this time RFID tag data (tag code, article code and article name) is stored in the RFID tag data table 74C. That is, the RFID tag data is stored in the RFID tag data column 74C1 of the RFID tag data table 74C, and a time data (reading time) that this time RFID tag data is received from the RFID tag reader section 50 is stored in the reading time column 74C2. No data are stored in the difference data column 74C3 and the renewal flag column 74C4, and thus the RFID tag reading process is completed.

In step S59 described above, if it is judged that a difference exists between this time RFID tag data and last time RFID tag data, YES-path is taken and step S61 is executed. Count operation of the timer 75 stops and the counted value thereof is cleared. In step S63, this time RFID tag data is stored in the RFID tag data table 74C such that the RFID tag data (tag code, article code and article name) is stored in the RFID tag data column 74C1 of the RFID tag data table 74C and a time data at which the RFID tag data is received from the RFID tag reader section 50 is stored in the reading time column 74C2. In addition, in step S65, this time RFID tag data different from last time RFID tag data is stored in the difference data column 74C3.

Next, in step S67, judgment is made whether this time RFID tag data stored in the difference data column 74C3 is an added data or a deleted data with respect to last time RFID tag data. If the difference in RFID tag data stored in the difference data column 74C3 is present in this time RFID tag data but is not present in last time RFID tag data, it is determined as an added data. On the contrary, if the difference in RFID tag data is present in last time RFID tag data but it is not present in this time RFID tag data, it is determined as a deleted data.

In step S67, when judgment is made that it is not an added data, No-path is taken and step S71 is carried out. Zero “0” is stored as a flag in the renewal flag column 74C4 and then the RFID tag reading process is finished. The flag “0” indicates that the RFID tag 11 storing the unique tag code is removed from the article display shelf 1 within the communication area of the RFID tag reader section 50.

On the other hand, when judgment is made that it is an added data in step S67, YES-path is taken and step S69 is executed. One “1” is stored in the renewal flag column 74C4 of the RFID tag data table 74C as a flag and the RFID tag reading process is finished. The flag “1” indicates that the RFID tag having the unique tag code is newly added on the article display shelf 1 within the communication area of the RFID tag reader section 50.

By the above-described processes, a judgment is made based on the data read out of the RFID tag 11 whether or not an article 3 is taken into or away from the article display shelf 1 within the communication area of the RFID tag reader section 50.

Returning to the flow chart shown in FIG. 15, it is judged whether or not changes in the RFID tag data present in step S5. If “1” and “0” are not stored in the renewal flag column 74C4 of the RFID tag data table 74C in which the received RFID tag data is stored, NO-path is taken and step S9 is executed. In this case, since the read result of the RFID tag 11 is not changed irrespective of an access of the object 7 being detected, it is considered that the RFID tag reader section 50 or the RFID tag 11 may be damaged. Thus, in step S9, alarm information such as, e.g., sound or message, etc, is output to notify it to a shop clerk and after that it returns to step S1.

On the other hand, in step S5, if “1” or “0” is stored in the renewal flag column 74C4 of the RFID tag data table 74C, YES-path is taken and step S7 is executed. In step S7, an article location specifying process is executed.

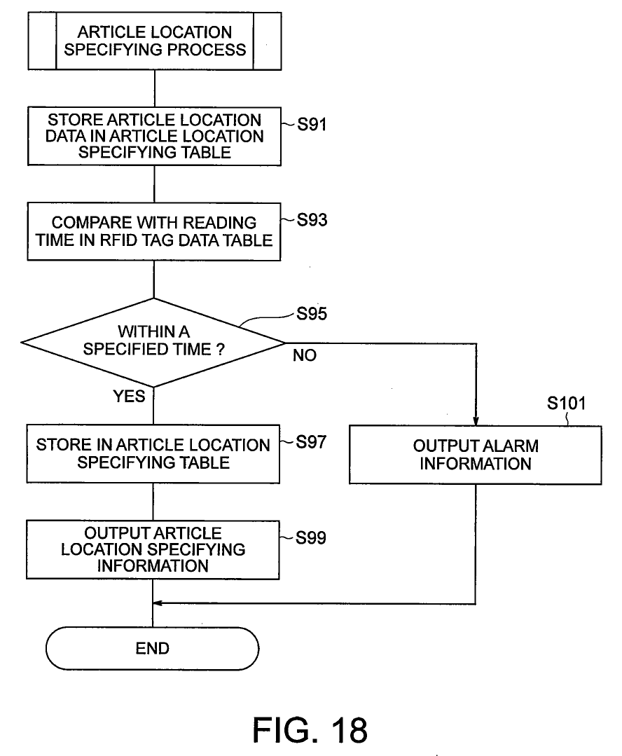

FIG. 18 is a flow chart illustrating an article location specifying process carried out by a control section (MPU 71) of the system management section 70

The article location specifying process functions as an article location specifying means. Firstly, the object location data (sensor identifying data, distance data, sensor detection time) in a record of the object location data table 74A at which “1” is stored in the detection object data column 74A4 of the table 74A is stored in the article location specifying table 74D (step S91). A shelf data corresponding to the sensor identifying data of the object location data is acquired from the shelf data column 74B2 of the valid area table 74B and the shelf data acquired is stored in the shelf data column 74D1 of the article location specifying table 74D. Other data of the object location data, i.e., distance and sensor detection time, are stored in the distance data column 74D2 and the sensor detection time data column 74D3 of the article location specifying table 74D, respectively.

Next, a detection time data of the sensor detection time data column 74D3 is compared with a reading time data of the RFID tag data received in the RFID tag data table 74C (step S93). In step S95, if a difference between the detection time data and the reading time data is more than a prescribed time, e.g., three (3) seconds, NO-path is taken and step S101 is carried out. In this case, it is understood that no changes in the reading result of the RFID tag 11 present within the prescribed time despite access of the object 7 being detected. Then, it is considered that there is a possibility that the sensor section 20, the RFID tag reader section 50 or the RFID tag may be damaged. Therefore, in step S101, alarm information such as, e.g., sound or message, is outputted to notify it to a shop clerk and the article location specifying process is terminated.

In step S95, if a difference between the detection time data and the reading time data is within the prescribed time, YES-path is taken and step S97 is executed. In step S97, the RFID tag data (tag code, article code and article name) is stored in the same record of the article location specifying table 74D in which the object location data (shelf data, distance data and sensor detection time) has been stored in step S91, as shown in FIG. 13. The tag code, article code and article name that have been stored in the difference data column 74C3 of the RFID tag data table 74C are read out and are stored in the tag code data column 74D4, article code data column 74D5 and article name column 74D6 of the article location specifying table 74D, respectively. In addition, the renewal flag that has been stored in the renewal flag column 74C4 of the RFID tag data table 74C is read out and is stored in the renewal flag column 74D7 of the article location specifying table 74D.

Next, as shown in FIG. 18, step S99 is executed. An article location specifying information is produced and outputted based on the article location data (shelf data, distance data and sensor detection time) and the RFID tag data (tag code, article code and article name) stored in the article location specifying table 74D. One example of the article location specifying information is displayed on the display screen 73a of the display section 73 of the system management section 70, as shown in FIG. 14.

If “1” is stored in the renewal flag column 74D7 of the article location specifying table 74D, it indicates that data is added. Thus, the location information (article display shelf and distance) of the article 3 which is newly added on the article display shelf 1, the time information (detection time) that indicates time the article 3 is added, the article name information that identifies the article 3 being added and the renewal information (addition) that indicates that the article 3 is added are displayed on the display screen 73a, as an article location specifying information.

On the other hand, if “0” is stored in the renewal flag column 74D7 of the article location specifying table 74D, it represents that data is deleted. The location information of the article 3 that is removed from the article display shelf 1, the time information that indicates time the article 3 is removed, the article name information that identifies the removed article and the renewal information (deletion) that indicates that the article 3 is removed are displayed on the display screen 73a, as an article location specifying information. Based on the article location specifying information displayed on the display screen 73a, the shop clerk can manage the location of article with his or her eyes.

The above-described display is executed (step S99) and the article location specifying process is finished. Then, the process returns to the main process (step S1) and waits in a standby state until an interruption signal from the article detection process is issued.

In the above-described first embodiment of the present invention, the article location specifying information is displayed on the display section. However, other embodiment can be possible. For example, an article location specifying information stored in the article location specifying table 74D is outputted to other software in the form of a data, and an article location management may be carried out by the software based on the article location specifying information outputted. On the other hand, the article location specifying information may be outputted by a printing means, e.g., printer, to manage it.

According to the first embodiment of the present invention, the article location data outputted from the sensor section 20 (article detection means) and the RFID tag data outputted from the RFID tag reader section 50 (radio tag reading means) are related with each other in the article location specifying table 74D. Therefore, based on the article location specifying table 74D, it is possible to output location information of the article 3 on the article display shelf 1 and identification information of the article 3. In particular, since the article location data is detected by the article detection means (photo sensor) different from the radio tag reading means (RFID tag reader), an interference of radio wave or a read error caused by the radio tag reading means can be prevented and thus location of the article can be surely specified.

Since the leaky transmission path shows a distribution in electric field intensity in which its electric field intensity is large near the path and gradually decreases as it comes away from the path in a direction perpendicular to the path, there is no possibility that a radio tag information is read out of the RFID tag that is not present within the communication area of the leaky transmission path. Therefore, an erroneous article management in which an object location information read out by the object reading means when the object approaches the table section is related to a radio tag information of the RFID tag attached to an article that only comes near the table section but is not placed on the table section can be prevented.

Since, in this embodiment, the switchover device is used, it is not necessary to prepare an RFID tag reader to respective leaky transmission paths in case that a plurality of leaky transmission paths are arranged and thus, it is easy to realize an article management system of the one embodiment of the present invention. It is also possible to arrange a lengthwise (single) leaky transmission path in consideration of its transmission/reception range without using the switchover device.

### Second Embodiment

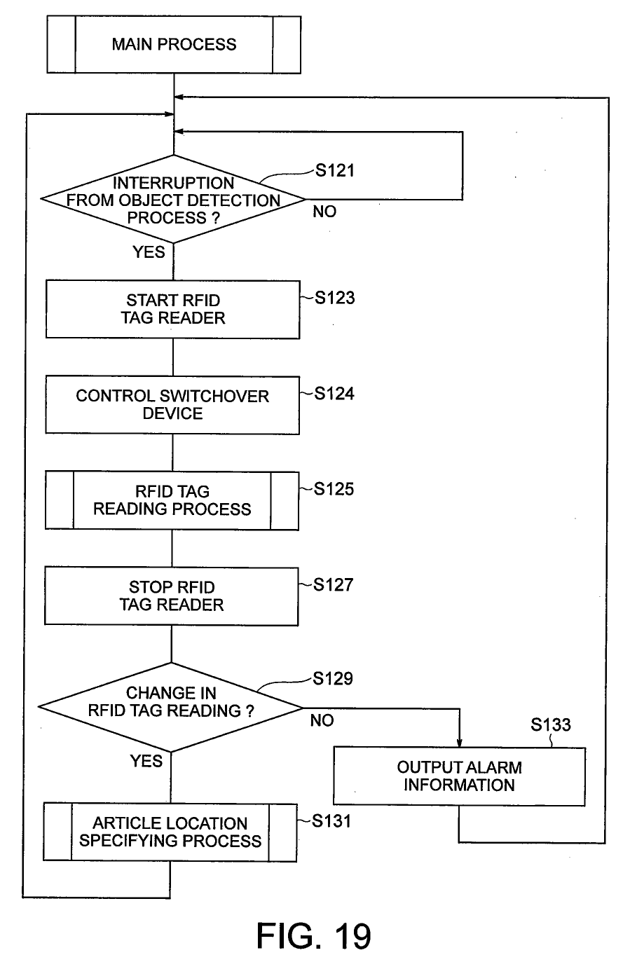

A second embodiment of the present invention will be described with reference to FIG. 19. In the above-described first embodiment, the RFID tag reader section 50 operates at nearly the same time as the system management section 70 starts. However, in the second embodiment, the RFID tag reader section 50 operates at a timing that an interruption process is occurred by the article detection process, as shown in FIG. 16.

FIG. 19 is a flow chart illustrating a main process carried out by the control section (MPU 71) of the system management section 70. MPU 71 is in a standby state in which it waits for occurrence of interruption from the article detection process in step S121.

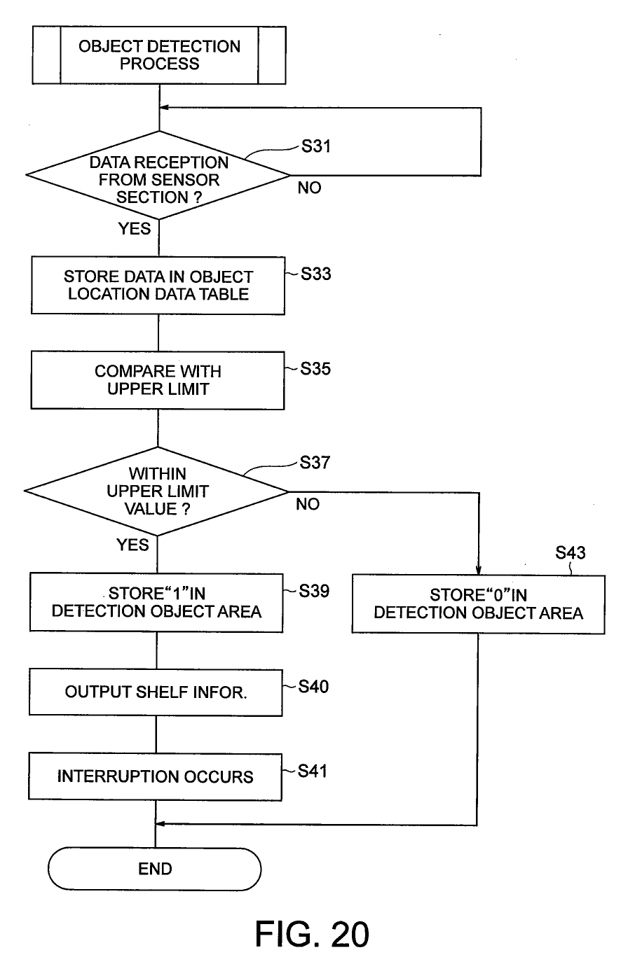

An object detection process according to the second embodiment will be described with reference to FIG. 20. FIG. 20 is a flowchart illustrating the object detection process carried out by MPU 71 of the management section 70. A point, which the object detection process of the second embodiment is different from that of the first embodiment, is that a shelf information as an object location data is output (step S40) after “1” is stored in the detection object data column 74A4 of the object location data table 74A (step S39).

The shelf information indicates one of the shelf elements of the article display shelf 1 that the object detected by the object detection means approaches and thus, it is sufficient to include information indicating the article display shelf 1 within the article location information output from the object detection means. The shelf information may include co-ordinates information showing a location of the article display shelf 1 in a numerical expression. The shelf information may also include image information indicating an arrangement of the article display shelf 1 that the leaky transmission path reads out to be able to analyze the image information by image processing at a later time.

In step S31 of FIG. 20, when the system management section 70 receives the object location data from the sensor section 20, YES-path is taken and the received object location data is stored in the object location data table 74A shown in FIG. 8 (step S33). The sensor identification data of the object location data is stored in the sensor identification data column 74A1, the distance data is stored in the distance data column 74A2 and the detection time data is stored in the sensor detection time data column 74A3.

Next, the distance data stored in the distance data column 74A2 of the object location data table 74A is compared with the upper limit value of each valid detection area 8a, 8b, 8c in the upper limit value data column 74B3 of the valid area table 74B (step S35).

If the distance data is within the upper limit value, YES-path is taken. It is judged that the object 7 is detected within the valid detection area 8 of the article display shelf 1, and “1” is stored in the detection object data column 74A4 of the object location data table 74A (step S39). After that, the shelf element information indicating a specific leaky transmission path corresponding to the sensor identification data that identifies each sensor is outputted. Then, in step S41, an interruption signal is issued to the main process and the object detection process is finished.

When interruption signal is generated in the object detection process, YES-path is taken and step S123 is carried out. In step S123, the RFID tag reader section 50 starts its operation. By starting the operation of the reader section 50, the RFID tag reading process is carried out (step S125), as shown in FIG. 17. Based on the shelf element information obtained in the object detection process, the switchover device 54 shown in FIG. 3 is controlled to select a specific leaky transmission path which reads out the RFID tag data of the RFID tag (step S124). The RFID tag reading process is carried out through the selected leaky transmission path (step S125). This RFID tag reading process is the same as that in the first embodiment and thus, the explanation thereof is not repeated.

When the RFID tag reading process is finished, the operation of the RFID tag reader section 50 stops in step S127. Next, in step S129, it is judged whether or not there is a change in the RFID tag data as a result of the RFID reading process. That is, it is judged whether “1” or “0” is stored in the renewal flag column 74C4 of the newest RFID tag data stored in the RFID data table 74C shown in FIG. 12.

If nothing is stored in the renewal flag column 74C4, NO-path is taken. In this case, despite there being detection of the article 7, it indicates no change in the reading result of the RFID tag 11. There is a possibility that the sensor section 20, the RFID tag reader section 50 or the RFID tag 11 may be out of order. Thus, in step S133, alarm information, such as, e.g., sound or message, is outputted to inform a shop clerk of it and the process returns to step S121.

In step S129, if it is judged that there is a change in the RFID tag data (“1” or “0” is stored in the renewal flag column 74C4 of the newest RFID tag data stored in the RFID data table 74C), YES-path is taken and the article location specifying process shown in FIG. 18 is executed in step S131. As similar to the above description, the article location specifying process of this embodiment is the same as that of the first embodiment and thus the explanation thereof is not repeated. When the article location specifying process is finished, the process returns to step S121.

According to the second embodiment, the location data of the article 3 placed on the article display shelf 1 is obtained from the object location data output from the sensor section 20 and the RFID tag data output by the RFID tag reader section 50 is obtained. The obtained object location data is related with the RFID tag data in the article location specifying table 74D. Thus, based on the article location specifying table 74D, it is possible to output the location information of the article 3 placed on the article display shelf 1 and the identification information of the article. In particular, since the object location data is detected by the object detection means (optical sensor) different from the RFID tag reading means (RFID tag reader), an interference of radio wave or a read error caused by the radio tag reading means can be prevented and thus location of the article can be surely specified.

In addition, operation of the RFID tag reader section 50 starts when the interruption signal is issued from the object detection process, and operation of the RFID tag reader section 50 stops when the RFID tag reading process is completed. Thus, the RFID tag reader section 50 (radio reading means) is operated only when the object detection means detects the object 7. Therefore, power consumption of the RFID reader section 50 is decreased and it is possible to construct a system with a low running cost.

For example, since it can specify the leaky transmission path corresponding to a place at which the object exists based on the shelf element information (object location information) outputted, the leaky transmission path, through which the RFID tag reading operation is carried out, is specified and used. It may possible to execute the RFID tag reading with high efficiency, compared with the case that the RFID tag reading is carried out by sequentially changing over leaky transmission paths arranged on respective shelf elements, correspondingly.

In the above embodiment, explanation is carried out with regard to the article management system that carries out an inventory management of an article such as a commodity or the like in a retail shop. However, the present invention is not limited to this system, and it may be applied to an article management system for parts or the like in a warehouse.

Also, in the above embodiments, the present invention is applied to an article display shelf arrangement in which a plurality of shelf elements for respectively displaying commodities are arranged in up and down direction. However, it can be applied to a table having a wide width on which a plurality of commodities are sectionally displayed or an article display stand such as a wagon or the like for housing commodities also.

The present invention has been described with respect to specific embodiments. However, other embodiments based on the principles of the present invention should be obvious to those of ordinary skill in the art. Such embodiments are intended to be covered by the claims.

What is claimed is:

1. An article management system comprising:
a leaky transmission path arranged at a table section on which an article is placed;
a radio tag reading means, which carries out a communication with a radio tag affixed on the article on the table section through the leaky transmission path, for outputting a radio tag information including an article identification information;
an object detection means for detecting an object approaching the table section for outputting an object location information; and
an article location specifying means, which relates the object location information with the article identification information, for outputting the result as a location information of the article.

2. A system according to claim 1, wherein the table section includes a plurality of table elements and a plurality of the leaky transmission paths are provided to be arranged to the respective table elements and wherein the radio tag reading means includes a switchover device sequentially switching over the leaky transmission paths arranged to the table elements.

3. A system according to claim 2, wherein the radio tag reading means acquires the object location information output from the object detection means and controls the switchover device based on the object location information.

4. A system according to claim 1 further including a memory section having an article location specifying table, the object location information and article identification information being related with one the other by the article location specifying table.

5. A system according to claim 1, wherein the radio tag reading means carries out a reading to the radio tag through the leaky transmission path when the object location information is output from the object detection means.

6. A system according to claim 1, wherein the article location specifying means includes a display for displaying the location information of the article

7. A method for managing an article placed on a table section, including the steps of:
placing on a table section an article to which a radio tag is affixed;
carrying out a communication with the radio tag of the article on the table section through a leaky transmission path to read a radio tag information including an article identification information from the radio tag;
detecting an object approaching the table section to output an object location information; and
relating the object location information with the article identification information to output the result as an article location information.

8. A method according to claim 7, wherein the table section includes a plurality of table elements and, a plurality of the leaky transmission paths are provided to be arranged to the plurality of table elements, respectively, further including the step of switching over the leaky transmission paths to communicate with the radio tag based on the object location information.

9. A method according to claim 7, wherein the communication with the radio tag of the article on the table section is carried out when the object location information is output.

10. A method according to claim 7 further including the step of displaying the location of the article based on the article location information.
